(19) United States
(12) Patent Application Publication
(10) Pub. No.: US 2026/0051310 A1
(43) Pub. Date: Feb. 19, 2026

(54) STRUCTURE AND HAPTIC PRESENTATION DEVICE

(71) Applicant: SONY GROUP CORPORATION, Tokyo (JP)

(72) Inventors: Atsushi YAMAMOTO, Tokyo (JP); Takayoshi YAMASAKI, Tokyo (JP); Osamu ITO, Tokyo (JP)

(21) Appl. No.: 19/103,547

(22) PCT Filed: Jun. 27, 2023
(86) PCT No.: PCT/JP2023/023718

§ 371 Date: Feb. 12, 2025

(30) Foreign Application Priority Data
Aug. 17, 2022 (JP) 2022-129955

(51) Int. Cl. G10K 11/162; G08B 6/00

(52) U.S. Cl. CPC G10K 11/162; G08B 6/00

(57) ABSTRACT

A structure according to an embodiment of the present technology includes a casing, a pressure generator, and an acoustic metamaterial. The casing includes at least one or more openings. The pressure generator is disposed in the casing and generates an air pressure toward the opening. The acoustic metamaterial is fitted into the opening and includes a first through-hole formed such that the air pressure passes through the first through-hole linearly, and a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.

### TECHNICAL FIELD

The present technology relates to a structure and a haptic presentation device that are applicable to haptic presentation or the like to a user.

### BACKGROUND ART

Patent Literature 1 describes a subwoofer including: a sound output unit provided on an interior panel of a vehicle; a housing provided in a clearance between the interior panel and the frame of the vehicle and extending from the sound output unit to a through-hole formed in the frame; and a labyrinth portion provided inside the housing. In this subwoofer, an opening opened to the outside of the frame through the through-hole is formed at an end of the housing on the side opposite to the sound output unit side, and the labyrinth portion includes a plurality of protrusions arranged in a staggered pattern so as to reduce, in the frequency band of the sound that has entered the housing, a sound pressure level in a frequency band different from the frequency band of the sound generated in the sound output unit. This aims to reduce the influence of noise infiltration (see paragraphs [0027] to [0031], FIG. 5, etc. of the specification of Patent Literature 1).

### CITATION LIST

### Patent Literature

Patent Literature 1: Japanese Patent Application Laid-open No. 2020-142552

### DISCLOSURE OF INVENTION

### Technical Problem

There is a need for a technology that can achieve an improvement in a user's sense of immersion as described above.

In view of the circumstances as described above, it is an object of the present technology to provide a structure and a haptic presentation device that can achieve an improvement in a user's sense of immersion.

### Solution to Problem

In order to achieve the object described above, a structure according to an embodiment of the present technology includes a casing, a pressure generator, and an acoustic metamaterial.

The casing includes at least one or more openings.

The pressure generator is disposed in the casing and generates an air pressure toward the opening.

The acoustic metamaterial is fitted into the opening and includes a first through-hole formed such that the air pressure passes through the first through-hole linearly, and a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.

Such a structure includes a pressure generator that is disposed in a casing and generates an air pressure toward at least one or more openings, and an acoustic metamaterial that is fitted into the opening and includes a first through-hole formed such that the air pressure passes through the first through-hole linearly, and a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94. This makes it possible to achieve an improvement in a user's sense of immersion.

The opening may be provided in a direction coaxial with a direction in which the air pressure is compressed by the pressure generator.

The opening may be provided in an axial direction different from a direction in which the air pressure is compressed by the pressure generator.

A sound-absorbing material may be disposed in the casing. In this case, the sound-absorbing material may be formed of a laminate of fibers or a porous material.

The pressure generator may include a voice coil motor or a fan.

The casing may include two or more of the openings. In this case, the acoustic metamaterial may be fitted into each of the openings.

The two or more of the openings may be opened in an identical direction. In this case, the casing may include a divider provided between the openings.

The second through-hole may have two or more types of angles.

The second through-hole may be formed to have the two or more types of angles in a vicinity of an outlet from which the air pressure is exhausted.

The acoustic metamaterial may include a magnetic circuit, and at least one or more of a cross-sectional area of a passage connecting an inlet and an outlet of the second through-hole, a length of the acoustic metamaterial in a direction coaxial with a direction in which the air pressure passes through the first through-hole, or an angle formed by the passage may dynamically change by driving of the magnetic circuit.

The first through-hole may be a columnar shape. In this case, the second through-hole may include a plurality of inlets and outlets.

A haptic presentation device according to an embodiment of the present technology includes a casing, a pressure generator, and an acoustic metamaterial.

The casing includes at least one or more openings opened toward a user.

The pressure generator is disposed in the casing and generates an air pressure toward the opening.

The acoustic metamaterial is fitted into the opening and includes a first through-hole formed such that the air pressure passes through the first through-hole linearly, and a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.

### BRIEF DESCRIPTION OF DRAWINGS

FIG. 1 is a view schematically showing a wind speed generator.

FIG. 2 shows graphs based on the design of an acoustic metamaterial.

FIG. 3 is a view schematically showing other examples of the wind speed generator.

FIG. 4 is a view showing a wind speed generator including two openings.

FIG. 5 is a schematic view showing another example of the acoustic metamaterial.

FIG. 6 is a schematic view showing another example of the acoustic metamaterial.

### MODE(S) FOR CARRYING OUT THE INVENTION

Hereinafter, an embodiment according to the present technology will be described with reference to the drawings.

### [Wind Speed Generator]

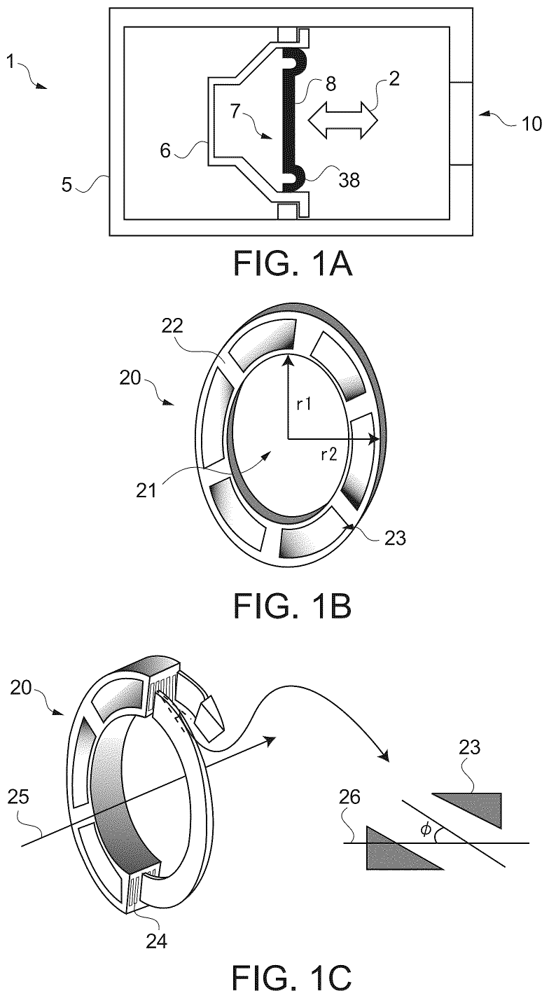

FIG. 1 is a view schematically showing a wind speed generator 2 according to the present technology. A of FIG. 1 is a view schematically showing a casing 5.

As shown in A of FIG. 1, the wind speed generator 1 includes the casing 5 and an acoustic metamaterial 20.

The casing 5 includes a voice coil motor 6, a piston 7, and an opening 10.

In the voice coil motor 6, a diaphragm 8 of the piston 7 moves translationally when voltage is applied. Thus, the air is compressed from the diaphragm 8, the air inside the casing 5 is pushed through the opening 10, and an air pressure propagates to a user, so that a tactile sensation is presented.

Note that the driving amount of the diaphragm 8 is determined according to conditions dependent on content such as a video being viewed by the user. In other words, a wind speed corresponding to a scene of the content, such as an explosion, is sent to the user, so that suitable tactile sensation presentation in a contactless manner is performed.

Additionally, in the voice coil motor 6, a speaker or a fan motor may be used, and if the following characteristics with respect to the changes of the video are considered, the shape of a speaker is favorable. In addition to this, air may be compressed by a pump or the like.

The opening 10 is provided in a direction coaxial with a direction in which the piston 7 is driven (direction of arrow 2). In other words, the opening 10 is provided in a direction coaxial with a direction formed by the main direction in which the air pushed by the piston 7 propagates. Additionally, in this embodiment, the acoustic metamaterial 20 is fitted into the opening 10. The acoustic metamaterial 20 is a structure having different acoustic impedances in the outer circumference portion and the center portion.

B of FIG. 1 is a view schematically showing an inlet of the acoustic metamaterial 20. C of FIG. 1 is a view schematically showing a cross-sectional view of the acoustic metamaterial 20 and a wind travelling direction.

Note that the inlet means a portion facing the inside of the casing 5 shown in A of FIG. 1. In other words, the inlet means a hole that air or sound enters. Similarly, the outlet means a portion facing the outside of the casing 5 shown in A of FIG. 1. In other words, the outlet means a hole from which air or sound exits.

As shown in B and C of FIG. 1, the acoustic metamaterial 20 includes a center portion 21 and an outer circumference portion 22. The outlet of the acoustic metamaterial 20 has a shape similar to that of the inlet shown in B of FIG. 1. In other words, in the case of B of FIG. 1, a helical portion 23 of the outer circumference portion 22 includes six inlets and similarly includes six outlets.

The center portion 21 has a hole parallel to an air or sound travelling direction (direction of arrow 25). In this embodiment, the center portion 21 has a cylindrical shape, and the shapes of the inlet and outlet are formed to be circular. Note that the shape of the center portion 21 is not limited and may be an oval or the like, the cross-sectional areas of the inlet and the outlet may be different from each other as in a triangular pyramid or the like, or the shapes of the inlet and the outlet may be different from each other.

Additionally, as shown in C of FIG. 1, each helical portion 23 of the outer circumference portion 22 includes a passage 24 that connects the inlet and the outlet. The passage 24 is formed to have a helical shape (spiral structure), and air or sound passing through the passage 24 moves spirally.

Note that a thickness t shown in C of FIG. 1 represents the length of the acoustic metamaterial 20 in the air or sound travelling direction (direction of arrow 25). In this embodiment, the thickness t is assumed to be 0.5 mm on the basis of a realistic design limit.

Additionally, an angle φ shown in C of FIG. 1 represents the angle of the passage 24. The angle of the passage 24 in this embodiment means the angle defined by a plane 26 perpendicular to the direction of the thickness t (direction of arrow 25) and the air or sound travelling direction.

The acoustic metamaterial 20 includes the center portion 21 having a columnar shape and the helical portion 23 having a helical shape, so that a wind speed generated from the piston 7 can be rectified. This makes it possible to improve the straight traveling property of air and also to reduce a sound pressure.

Thus, since the driving direction of the piston 7 and the direction defined by the main direction in which air propagates are in the coaxial direction, the wind traveling straight from the piston 7 directly blows against the user, which makes it possible to adapt to the changes corresponding to the scenes of content on a case-by-case basis.

Note that in this embodiment the voice coil motor 6 and the piston 7 function as a pressure generator that generates an air pressure.

Note that in this embodiment the center portion 21 corresponds to a first through-hole.

Note that in this embodiment the helical portion 23 corresponds a second through-hole.

Note that in this embodiment the angle φ corresponds to the angle defined by the passage.

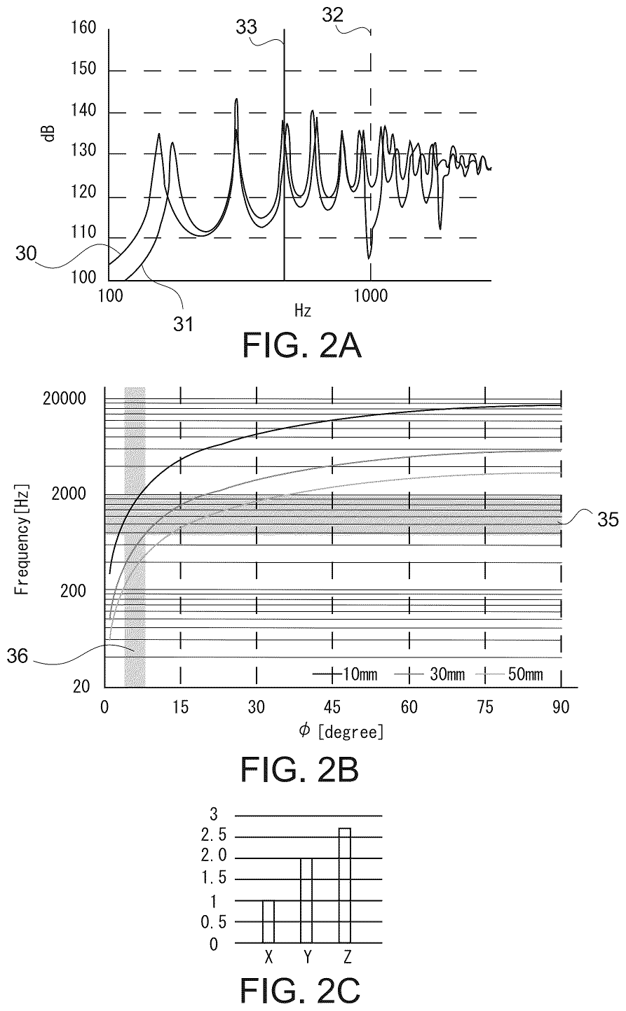

FIG. 2 shows graphs based on the design of the acoustic metamaterial 20.

A of FIG. 2 is a graph showing a comparison between the presence and the absence of the acoustic metamaterial 20. B of FIG. 2 is a graph showing a relationship between a sound-absorbing frequency f in the thickness t and the angle φ of the passage 24. C of FIG. 2 is a graph showing a specific exhaust efficiency in each setting.

A of FIG. 2 shows a graph 30 in which the acoustic metamaterial 20 is not applied, and a graph 31 in which the acoustic metamaterial is applied.

As shown in A of FIG. 2, the horizontal axis represents a frequency (Hz), and the vertical axis represents a sound pressure (dB). In this embodiment, a sound pressure at a location 100 mm away from the center of the opening 10 is calculated when the diaphragm 8 is driven at 1 m/s.

The decreasing portions in the graph 30 and the graph 31 indicate that the sound pressure is reduced because of the occurrence of resonance. Additionally, a line 32 indicates a frequency condition in which the sound pressure is reduced when the acoustic metamaterial 20 has a thickness of 10 mm. In addition, a line 33 indicates a frequency condition in which the sound pressure is reduced when the acoustic metamaterial 20 has a thickness of 15 mm. Note that the peaks of the graph 30 and the graph 31 are deviated at some locations, because standing waves are deviated due to the acoustic metamaterial 20 fitted.

In other words, the acoustic metamaterial 20 is fitted into the opening 10, and thus the sound pressure of the air pushed from the piston 7 is reduced. Note that in this embodiment the tactile sensation presentation by an air blowing method that is provided to the user is for the sound in the frequency band of 1 kHz or below.

This makes it possible to deliver a tactile sensation by using air to the user and also provide a sound-muffling effect.

As shown in B of FIG. 2, the horizontal axis represents the angle of the passage 24, and the vertical axis represents the frequency (Hz) of the sound-absorbing frequency. In this embodiment, it is assumed that a user (target to which a tactile sensation is presented using air) is located 100 mm ahead from the wind speed generator 1. In this case, in order to provide sufficient haptic presentation to the user, the wind speed generator 1 requires a flow speed of 5 m/s or higher at a location 100 mm ahead.

In this embodiment, the acoustic metamaterial 20 is fitted into the opening 10, and thus the straight traveling property of air is increased by the helical shape of the outer circumference portion 22, and the straight traveling property of air passing through the center portion 21 is also enhanced.

C of FIG. 2 shows a graph comparing the degree to which a wind speed at a location 100 mm ahead is increased between a wind speed generator X including an opening 10 provided to a casing 5 as in A of FIG. 1, a two-hole wind speed generator Y including a new opening provided to the back surface of a diaphragm 8 (a position facing the opening 10), and a wind speed generator Z including acoustic metamaterials 20 respectively fitted into the two openings.

As shown in C of FIG. 2, simulations show that, assuming that a wind speed at a location 100 mm ahead in the wind speed generator X is 1, the wind speed in the wind speed generator Y is doubled, whereas the wind speed in the wind speed generator Z is 1.25 times higher per opening.

Additionally, assuming that a sound speed is constant, a vanishing frequency f in the acoustic metamaterial is determined on the basis of the angle (p) of the helical shape and the thickness t, and the following equation is obtained.

f=C0/λ=C0N sin(φ)/2t

C0 represents a sound speed. Additionally, N represents an integer, which means that a sound pressure decreases in integer multiples.

Additionally, a sound-absorbing ratio in the acoustic metamaterial is determined by a radius r1 of the center portion 21 and a radius r2 of the outer circumference portion 22 including the helical portion 23, and the following equation is obtained (see B of FIG. 1).

Z2/Z1=πr1\hat{ }2/t(r2−r1)

Here, Z1 represents an acoustic impedance in the helical portion 23. Additionally, Z2 represents an acoustic impedance of the center portion 21.

If the above ratio of the acoustic impedances is infinite, a sound-absorbing effect decreases. In other words, the frequency is determined by the angle of the helical portion 23 and the thickness of the acoustic metamaterial, and the amount of reduced sound pressure is determined by the ratio of the acoustic impedances.

In B of FIG. 2, since the frequency band in this embodiment is 1 kHz or below, a target region 35 of the sound-absorbing frequency f is set. Note that the sound-absorbing frequency means a frequency of the sound reduced by the acoustic metamaterial 20. As shown in B of FIG. 2, the sound-absorbing frequency f and the angle φ of the passage 24 are shown when the acoustic metamaterial 20 has a thickness of 10 mm, 30 mm, and 50 mm.

Additionally, a region 36 shown in B of FIG. 2 means the realistically designable angle of the passage 24. In other words, if the angle φ is too large, it is difficult to achieve realistic design due to the thickness of the acoustic metamaterial 20, the number of rotations of the helical portion 23, and the like. In other words, the angle φ of the passage 24 of the acoustic metamaterial 20 in this embodiment takes a value less than 15 degrees.

The wind speed in the vicinity of the outlet of the acoustic metamaterial 20 that has been obtained in the simulations is 10 m/s, and the inner diameter of the acoustic metamaterial 20 (diameter of center portion 21) is set to 20 mm, so that the flow rate can be defined.

Here, assuming that the thickness of the acoustic metamaterial 20 is 0.5 mm, which is a realistic design limit, and as a configuration to achieve the effect of the present invention when the hearing range is 20 kHz or below, a ratio R of a cross-sectional area S′ of the acoustic metamaterial 20 to an effective area S of the wind speed generator 1 is determined from the following equation.

R=S′/S=(r1\hat{ }2π+(r2\hat{ }2−r1\hat{ }2)0.5π)/S<0.94

Here, the effective cross-sectional area S represents an area of the diaphragm 8 including an edge portion 38 of the piston 7 (see A of FIG. 1). Additionally, the cross-sectional area S′ represents an area obtained by adding the area of the outlet of the center portion 21 and the areas of the outlets of the helical portion 23.

In other words, in this embodiment, the ratio of the cross-sectional area S′ of the acoustic metamaterial 20 to the effective cross-sectional area S is designed to be 0.94 or less.

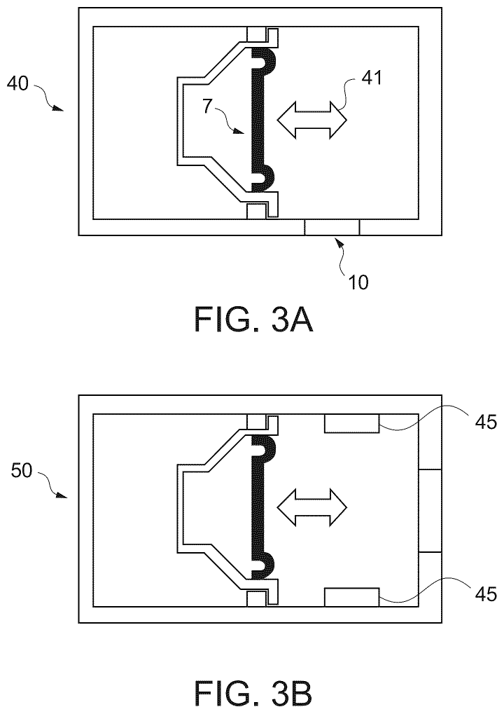

FIG. 3 is a view schematically showing other examples of a wind speed generator 40.

A of FIG. 3 is a view when the position of the opening 10 is different from that in the wind speed generator 1 shown in FIG. 1. As shown in A of FIG. 3, the wind speed generator 40 includes an opening 10 in an axial direction different from the driving direction of the piston 7 (direction of arrow 41). Thus, changing the positional relationship of the outlet for wind makes it possible to save space for a device including the wind speed generator 40.

B of FIG. 3 is a view of a wind speed generator 50 to which a sound-absorbing material 45 is added. As shown in B of FIG. 3, the wind speed generator 50 includes the sound-absorbing material 45 on the wall surface inside the casing 51. For example, the sound-absorbing material 45 is formed of a porous material or a structure of fibers folded back on themselves. This can reduce the sound pressure on the high-frequency side. Note that the position at which the sound-absorbing material 45 is disposed, the number, material, and the like of the sound-absorbing material 45 are not limited.

Additionally, other than the examples described above, power units of the voice coil motor 6 and the piston 7 may be a fan motor. This makes it possible to reduce the sound pressure of wind even in a configuration with a high drive responsiveness to a change in angle of a blade portion, or the like. Note that in this case the effective cross-sectional area S is the area formed by a propeller portion of the fan. In other words, the effective cross-sectional area S is the sum of the cross-sectional areas of a plurality of blades constituting the propeller portion.

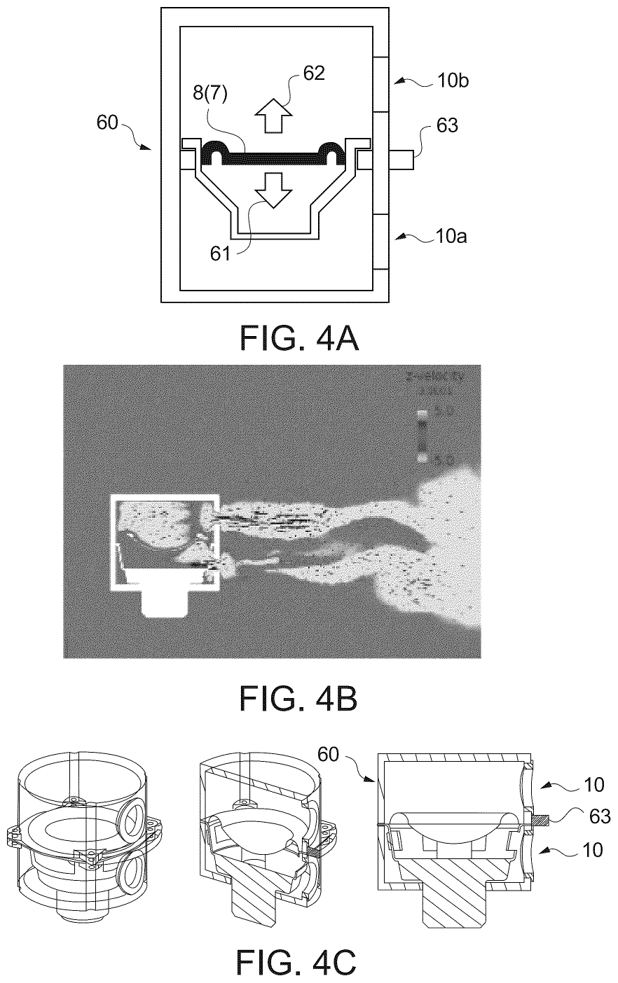

FIG. 4 is a view showing a wind speed generator including two openings. A of FIG. 4 schematically shows a wind speed generator 60. B of FIG. 4 is a view showing the flow of the air exhausted from the wind speed generator 60. C of FIG. 4 shows an overhead view and a cross-sectional view of the wind speed generator 60.

As shown in FIG. 4, two openings 10 are provided in both directions of the driving direction of the diaphragm 8. Hereinafter, the direction of an arrow 61, in which the diaphragm 8 is driven, is referred to as a downward direction, and the direction of an arrow 62 is referred to as an upward direction. Additionally, the room in the downward direction inside the casing 5 that is divided by the piston 7 is referred to as an inner chamber A, and the room in the upward direction is referred to as an inner chamber B.

As shown in A of FIG. 4, the wind speed generator 60 includes an opening 10a for exhausting the air pushed by the diaphragm 8 from the inner chamber A, and an opening 10b for exhausting the air pushed by the diaphragm 8 from the inner chamber B.

Although not shown in FIG. 4, the acoustic metamaterials 20 are respectively fitted into the opening 10a and the opening 10b.

Note that, typically, the thickness of the opening 10 (length in the direction perpendicular to the driving direction of the piston 7) substantially coincides with the thickness of the acoustic metamaterial 20. If it does not coincide, the acoustic metamaterial 20 protrudes from the opening 10 to the inside of the casing 5 or to the outside of the casing 5. In this case, whether the acoustic metamaterial 20 protrudes to the inside of the casing 5 or to the outside of the casing 5 may be discretionally set. For example, in the case of the inner chamber A, the acoustic metamaterial 20 may protrude to the outside of the casing 5 if the position of the acoustic metamaterial 20 is limited by the voice coil motor 6.

As shown in B of FIG. 4, the diaphragm 8 is driven in the upward and downward directions, so that the air is exhausted from the opening 10a and the opening 10b. As shown in C of FIG. 2, fitting the acoustic metamaterials 20 into the two openings 10 makes it possible to improve an air exhaust efficiency and to present the air with a flow speed of 5 m/s or higher to the user located 100 mm ahead.

Additionally, a divider 63 is provided between the opening 10a and the opening 10b outside the casing 5 of the wind speed generator 60. The divider 63 rectifies the air exhausted from the opening 10a and the opening 10b. This makes it possible to increase the straight traveling property of the air. Additionally, the acoustic metamaterials 20 are fitted into both of the two openings 10, which makes it possible to reduce the sound pressure when an exhaust pressure portion is used for the wind speed.

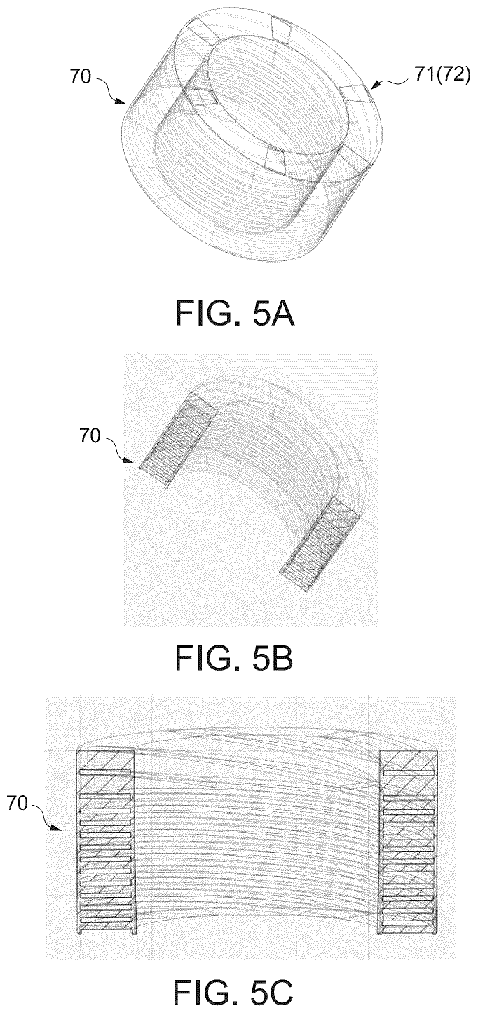

FIG. 5 is a schematic view showing another example of an acoustic metamaterial 70. A of FIG. 5 shows an overhead view of the acoustic metamaterial 70. B and C of FIG. 5 show cross-sectional views of the acoustic metamaterial 70.

FIG. 5 shows the acoustic metamaterial 70 when a helical portion 71 has two or more types of angles. In this embodiment, a helical portion 71 in the vicinity of an outlet 72 of the acoustic metamaterial 70 has two or more types of angles.

This generates a difference in acoustic impedance due to the spiral structure, which worsens the amount of reduced sound pressure, but can increase the straight traveling property of wind.

Note that the two or more types of angles of the helical portion 71 may be formed from the inlet. Additionally, the passage of the helical portion 71 may be driven to dynamically change the angles.

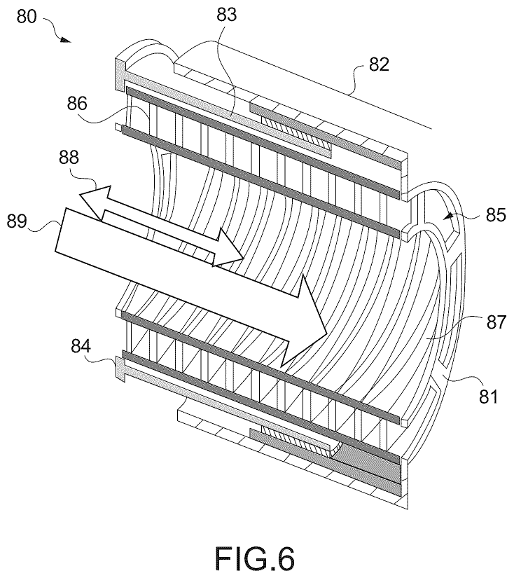

FIG. 6 is a schematic view showing another example of an acoustic metamaterial 80.

As shown in FIG. 6, the acoustic metamaterial 80 includes a magnet 82 that is fixed so as to cover an outer circumference portion 81, a coil 83 dynamically driven, a fixed coil 84, a metal 86 provided to a helical portion 85, and a magnet 87 provided inside the acoustic metamaterial 80.

In FIG. 6, the acoustic metamaterial 80 includes a magnetic circuit as described above. The magnetic circuit is driven in a direction of an arrow 88, so that the thickness of the passage in the helical portion 85 (length in a direction perpendicular to the direction of air flowing through the passage), the thickness t of the acoustic metamaterial 80 (length in a direction coaxial with an air direction 89), and the angle φ of the passage are changed dynamically.

This makes it possible to form the shape of the acoustic metamaterial that corresponds to the frequency generated from the voice coil motor 6 and is suitable for such frequency.

Hereinabove, the wind speed generator 1 according to this embodiment includes: a casing 5 including at least one or more openings 10; a voice coil motor 6 and a piston 7 that are disposed in the casing 5 and generate an air pressure toward the opening 10; and an acoustic metamaterial 20 that is fitted into the opening 10 and includes a center portion 21 formed such that the air pressure passes through the center portion 21 linearly, and a helical portion 23 formed such that the air pressure passes through the helical portion 23 spirally, the acoustic metamaterial 20 being formed such that a ratio of a sum of a cross-sectional area of the center portion 21 and a cross-sectional area of the helical portion 23 to an effective cross-sectional area of the piston 7 is smaller than 0.94. This makes it possible to achieve an improvement in the user's sense of immersion.

Conventionally, in the tactile sensation presentation by a contactless method, wind has been provided to a user in conjunction with scenes such as explosions. Ultrasonic waves are used as an example of the contactless method, but their practical use is difficult due to the risk of direct contact with the eardrums. In addition, when air is sent, noise corresponding to the wind speed is generated due to a discharge pressure, and thus the sound of the content may be disturbed. Especially in the case of small devices such as those used in households, because of the lack of wind output, measures against noise do not contribute to the lack of output.

Additionally, as the measures against noise, the sound-absorbing material is used for a bandwidth of 1 kHz or above as the characteristics of the sound-absorbing material. On the other hand, when a tactile sensation is presented by sending air, it is operated in the frequency band of 1 kHz or below. Therefore, it is difficult to muffle the sound by using the sound-absorbing material. Additionally, in the case of the structure to cancel out the sounds with each other, when a low-frequency band is targeted, the design size becomes large due to the length of the wavelength, and thus portability is reduced.

In the present technology, the acoustic metamaterial is fitted into the opening, the acoustic metamaterial including: a first through-hole formed such that the air pressure passes therethrough linearly; and a second through-hole formed such that the air pressure passes therethrough spirally. Additionally, the acoustic metamaterial is formed such that a ratio of a cross-sectional area of the acoustic metamaterial to an effective cross-sectional area of the pressure generator is smaller than 0.94. Thus, with the second through-hole having a helical shape, a difference in the pressure drop of the air is provided, and the straight traveling property of the wind passing through the first through-hole is improved. Additionally, the structure formed by the first through-hole that allows the air pressure to travel straight and the second through-hole having a helical shape also provides a sound-muffling effect.

Note that the effects described in the present disclosure are not limitative but are merely illustrative, and other effects may be provided. The description on the plurality of effects does not mean that those effects are not necessarily exerted at the same time. It means that at least any of the effects described above is obtained depending on conditions or the like, and as a matter of course, effects not described in the present disclosure may be exerted.

At least two of the characteristic portions according to each embodiment described above can be combined. In other words, the various characteristic portions described in each embodiment may be discretionarily combined without distinguishing between the embodiments.

Note that the present technology may also take the following configurations.
(1) A structure, including:
   a casing including at least one or more openings;
   a pressure generator that is disposed in the casing and generates an air pressure toward the opening; and
   an acoustic metamaterial that is fitted into the opening and includes
      a first through-hole formed such that the air pressure passes through the first through-hole linearly, and
      a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.
(2) The structure according to (1), in which
   the opening is provided in a direction coaxial with a direction in which the air pressure is compressed by the pressure generator.
(3) The structure according to (1), in which
   the opening is provided in an axial direction different from a direction in which the air pressure is compressed by the pressure generator.
(4) The structure according to (1), in which
   a sound-absorbing material is disposed in the casing, and
   the sound-absorbing material is formed of a laminate of fibers or a porous material.
(5) The structure according to (1), in which
   the pressure generator includes a voice coil motor or a fan.
(6) The structure according to (1), in which
   the casing includes two or more of the openings, and
   the acoustic metamaterial is fitted into each of the openings.
(7) The structure according to (6), in which
   the two or more of the openings are opened in an identical direction, and
   the casing includes a divider provided between the openings.
(8) The structure according to (1), in which
   the second through-hole has two or more types of angles.
(9) The structure according to (8), in which
   the second through-hole is formed to have the two or more types of angles in a vicinity of an outlet from which the air pressure is exhausted.
(10) The structure according to (1), in which
   the acoustic metamaterial includes a magnetic circuit, and
   at least one or more of a cross-sectional area of a passage connecting an inlet and an outlet of the second through-hole, a length of the acoustic metamaterial in a direction coaxial with a direction in which the air pressure passes through the first through-hole, or an angle formed by the passage dynamically change by driving of the magnetic circuit.
(11) The structure according to (1), in which
   the first through-hole is a columnar shape, and
   the second through-hole includes a plurality of inlets and outlets.
(12) A haptic presentation device, including:
   a casing including at least one or more openings opened toward a user;
   a pressure generator that is disposed in the casing and generates an air pressure toward the opening; and
   an acoustic metamaterial that is fitted into the opening and includes
      a first through-hole formed such that the air pressure passes through the first through-hole linearly, and
      a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.

### REFERENCE SIGNS LIST

1 wind speed generator
5 casing
6 voice coil motor
7 piston
10 opening
20 acoustic metamaterial
21 center portion
23 helical portion

What is claimed is:

1. A structure, comprising:
a casing including at least one or more openings;
a pressure generator that is disposed in the casing and generates an air pressure toward the opening; and
an acoustic metamaterial that is fitted into the opening and includes
a first through-hole formed such that the air pressure passes through the first through-hole linearly, and
a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.

2. The structure according to claim 1, wherein
the opening is provided in a direction coaxial with a direction in which the air pressure is compressed by the pressure generator.

3. The structure according to claim 1, wherein
the opening is provided in an axial direction different from a direction in which the air pressure is compressed by the pressure generator.

4. The structure according to claim 1, wherein
a sound-absorbing material is disposed in the casing, and
the sound-absorbing material is formed of a laminate of fibers or a porous material.

5. The structure according to claim 1, wherein
the pressure generator includes a voice coil motor or a fan.

6. The structure according to claim 1, wherein
the casing includes two or more of the openings, and
the acoustic metamaterial is fitted into each of the openings.

7. The structure according to claim 6, wherein
the two or more of the openings are opened in an identical direction, and
the casing includes a divider provided between the openings.

8. The structure according to claim 1, wherein
the second through-hole has two or more types of angles.

9. The structure according to claim 8, wherein
the second through-hole is formed to have the two or more types of angles in a vicinity of an outlet from which the air pressure is exhausted.

10. The structure according to claim 1, wherein
the acoustic metamaterial includes a magnetic circuit, and
at least one or more of a cross-sectional area of a passage connecting an inlet and an outlet of the second through-hole, a length of the acoustic metamaterial in a direction coaxial with a direction in which the air pressure passes through the first through-hole, or an angle formed by the passage dynamically change by driving of the magnetic circuit.

11. The structure according to claim 1, wherein
the first through-hole is a columnar shape, and
the second through-hole includes a plurality of inlets and outlets.

12. A haptic presentation device, comprising:
a casing including at least one or more openings opened toward a user;
a pressure generator that is disposed in the casing and generates an air pressure toward the opening; and
an acoustic metamaterial that is fitted into the opening and includes
a first through-hole formed such that the air pressure passes through the first through-hole linearly, and
a second through-hole formed such that the air pressure passes through the second through-hole spirally, the acoustic metamaterial being formed such that a ratio of a sum of a cross-sectional area of the first through-hole and a cross-sectional area of the second through-hole to a cross-sectional area of the pressure generator is smaller than 0.94.
